(19) United States
(12) Patent Application Publication
(10) Pub. No.: US 2024/0140158 A1
(43) Pub. Date: May 2, 2024

(54) FORCE-MEASURING DEVICE

(71) Applicant: ZF CV Systems Europe BV, Brussels (BE)

(72) Inventors: Oliver Topic, Hannover (DE); Thomas Wolf, Barsinghausen (DE)

(21) Appl. No.: 18/402,395

(22) Filed: Jan. 2, 2024

Related U.S. Application Data
(63) Continuation of application No. PCT/EP2022/068567, filed on Jul. 5, 2022.

(30) Foreign Application Priority Data
Jul. 5, 2021 (DE) 10 2021 117 213.6

(51) Int. Cl. B60G 11/113

(52) U.S. Cl. CPC B60G 11/113; B60G 2202/112

(57) ABSTRACT

A device measures forces in a sprung chassis of a single-axle or multi-axle vehicle, in the force transmission path between the superstructure and the axle. Spring elements arranged between the axle and the superstructure are each connected to the axle and/or to the superstructure via a load-bearing element. The load-bearing element is made of an elastically deformable plastic or of an elastomeric material, and incorporated within the load-bearing element there are electrically conductive elements that are mutually spaced apart and insulated from one another, and that are variable absolutely and/or relative to one another in their position or geometry by a deformation of the load-bearing element effected under load, and thereby generate a detectable electrical quantity that is proportional to the elastic deformation of the load-bearing element.

### CROSS-REFERENCE TO RELATED APPLICATIONS

This application is a continuation application of international patent application PCT/EP2022/068567, filed Jul. 5, 2022, designating the United States and claiming priority from German application 10 2021 117 213.6, filed Jul. 5, 2021, and the entire content of both applications is incorporated herein by reference.

### TECHNICAL FIELD

The disclosure relates to a device for measuring forces in a sprung chassis of a single-axle or multi-axle vehicle, wherein the force-measuring device is realized as a load-bearing element and is provided in the force transmission path between the superstructure and the axle in such a way that spring elements arranged between the axle and the superstructure are each connected to the axle and/or to the superstructure via the load-bearing element.

In the case of trucks, in particular, the weight of the load significantly affects driving behavior, and thus driving safety. Determining or measuring the weight, or mass, of the vehicle and its distribution over individual axles or wheels is therefore an important basis for safe transport. For this reason also, there also legal regulations worldwide that prohibit the overloading of heavy goods vehicles or, also, other vehicles. In the Federal Republic of Germany, for example, the Federal Motor Transport Authority specifies the payload and the permissible gross weight as fixed quantities within the framework of the general operating license.

At the same time, it is often mandatory to check the loading, or axle load, of such vehicles before the start of the journey or during loading. The usual method for determining the weight of trucks is to weigh the vehicle on a stationary scale, which must be driven on before the journey begins. In addition, a check is often required during the journey, or after multiple loading and unloading operations, during a delivery journey. This may then be realized with use of appropriate mobile scales, but these are not always available.

It is therefore more advantageous if determination of the weight is effected by use of measuring device that are installed in the vehicle. In addition to car and truck manufacturers, such solutions are of course also of great interest to fleet operators and freight forwarders, as they enable load planning to be effected in a precise, anticipatory manner.

The problem of determining the weight within a vehicle is less significant in the case of vehicles that have air suspension, as here the load on the vehicle can be determined by analyzing, for example, the air pressure in the springs. Of course, this is not possible in the case of trucks that have leaf-spring/steel suspension. In the prior art, there are already solutions for determining the weight of vehicles that have mechanical suspension/leaf-spring suspension, in which the weight, or the vehicle mass, and the load on individual axles can be measured using measuring device or measuring devices in the vehicle.

DE 10 2019 202 763 A1 discloses such a measuring device, but only for measurement when the vehicle is stationary. There, the measuring device is arranged in a spring shackle by which a leaf-spring element is connected to the superstructure element, or the body. The deformation of the spring shackle is determined via strain gauges. Such a configuration is relatively complex and requires a lot of maintenance.

DE 199 18 679 A1 discloses an electronic measuring system that has a transducer fastened to the vehicle for determining the bearing mass of a vehicle. The transducer in this case can be integrated in a shock absorber and sense the force acting there. However, a shock absorber in a chassis is one of a plurality of load-bearing points on an axle and is arranged parallel to a suspension, which absorbs the “actual” weight load. Such a shock absorber is more suitable for determining dynamic forces than for determining static bearing forces. A measuring system arranged on the shock absorber is therefore less suitable for load measurements when stationary.

### SUMMARY

Accordingly, an object of the present disclosure is to provide an improved measuring device integrated in the vehicle, with the aid of which forces in a sprung chassis of a single-axle or multi-axle vehicle, in particular weight forces caused by the loading of the vehicle, can be measured in a simple manner. In addition, the measurement is to be effected not only when the vehicle is stationary, but at any time, that is, also during travel or as part of checks during breaks in the journey. The object was also to make the measuring device as simple as possible and to integrate it into standard axle or chassis components.

The force-measuring device in the vehicle is realized in this case as a load-bearing element, made substantially of elastically deformable plastic or elastomeric material, in the force transmission path between the superstructure and the axle, wherein incorporated within the load-bearing element there are electrodes, electrically conductive layers or electrically conductive elements that are mutually spaced apart and insulated from one another by the elastically deformable plastic or the elastomeric material, and that are variable absolutely and/or relative to one another in their position or geometry by a deformation of the load-bearing element effected under load, and thereby generate a detectable electrical quantity that is proportional to the elastic deformation of the load-bearing element.

Insofar as reference is made to elastomeric material in the rest of the description that follows, it is also intended that elastically deformable plastic be included in each case.

An advantage of such a force-measuring device according to the disclosure is, on the one hand, that static forces can also be measured directly, that is, also a variation in weight during the loading of a vehicle when stationary, or dynamic variations during travel. The deformation of the load-bearing element, for example a load-bearing element made of rubber, results in variation in the position, or geometry, of the electrically conductive elements or layers within the rubber matrix, and can be read out as a detectable electrical quantity that is proportional to the deformation, that is, to the weight loading.

A change in the electrical quantity may be read out, for example, via conventional cables, via antennae, sensors or field detectors. It is also possible for electrical energy to be supplied to the electrical elements, the conductive layers or the electrodes via cables, antennae or corresponding transmitters arranged in the vicinity of the load-bearing elements. In principle, a person skilled in the art is familiar with such systems from near-field communication, transponder or RFID technology.

On the other hand, the configurations according to the disclosure allow the force-measuring device to be produced and constructed in a very simple manner and to be integrated within or between chassis components without major assembly work. This makes it possible to provide standard components that can be combined with corresponding read devices or transmitters and installed in all chassis constructions.

An advantageous embodiment involves planar electrodes or electrically conductive layers that are arranged within the load-bearing element and mutually spaced apart are provided and form a capacitive resistor, the capacitance of which is variable in proportion to the elastic deformation of the load-bearing element and is detectable. Capacitive systems are easy to produce and cause little difficulty in the interpretation and detection of a variation in capacitance. The relevant equation here, which describes the capacitance that is variable as a result of deformation, namely the variation in the position, or geometry, of two electrodes or electrically conductive layers arranged in a planar manner, is as follows

C=ε₀εᵣA/d

where
ε₀=electric field constant in a vacuum
εᵣ=relative permittivity of the elastomeric material (dielectric)
A=surface area of the electrode
d=distance between the electrodes

A variation in the distance between two parallel electrodes caused by the deformation of the load-bearing element, that is, the elastomeric body, thus produces a measurable variation in capacitance. The same happens when the electrode surface area is varied by a deformation of the elastomeric material. This variation in capacitance can be measured by the sensors and means already mentioned above, and is then used, after appropriate calibration, to determine the load weight. With appropriately configured layers or electrodes, both effects, change in distance and change in surface area, are present, such that the signal that can be read out after a variation in capacitance is amplified.

A further advantageous embodiment is that the load-bearing element is of a multi-part configuration and/or composed of a plurality of elastomeric materials.

In the case of a multi-part configuration of the load-bearing element, it is thus possible, for instance, for the load-bearing element to be composed of a plurality of components or layers, at least one of which has the arrangement of mutually insulated electrodes, electrically conductive layers or electrically conductive elements. Such a construction may be composed, for example, of an upper layer of a conventional elastomeric material, an intermediate layer of a load-bearing element, realized according to the disclosure, that constitutes the measuring device, and a lower layer, again made of conventional elastomeric material. An advantage of such a configuration is that the measuring device can be produced as a separate standard part and, depending on the application, can be vulcanized, or connected, to differing configurations of upper and lower parts made of an elastomeric material, such that adaptation to the respective intended use, to the sought deformation behavior and to the type of installation can be achieved without difficulty. A further advantageous configuration includes a plurality of groups of electrodes, electrically conductive layers or electrically conductive elements that each act in combination are arranged in groups next to one another within the load-bearing element in such a way that an electrical quantity that is proportional to the elastic deformation of sub-regions of the load-bearing element can be generated. With such an arrangement, the load on individual sub-regions of the load-bearing element can then be determined according to the above equation. With a corresponding calibration and computational analysis, conclusions can be drawn therefrom about the load distribution and any uneven loading when the vehicle is stationary. If the measuring device is used while the vehicle is travelling, braking or acceleration forces can of course also be determined and used for vehicle control, with correspondingly rapid processing of the signals in an on-board computer. It is also possible to determine lateral forces or shear forces acting upon the load-bearing element by comparing the signals from the individual groups of electrodes that each act in combination.

A further advantageous configuration includes that a plurality of groups of electrodes, electrically conductive layers or electrically conductive elements that each act in combination are arranged in groups above one another within the load-bearing element in such a way that an electrical quantity that is proportional to the elastic displacement or torsion of the load-bearing element can be generated. With the use of appropriately adapted calibration and computational analysis, shear forces acting upon the load-bearing element can be determined, in particular based on the variation in or displacement of the electrode surface areas relative to one other. The arrangement of a plurality of groups of electrodes arranged one above the other, that is, transversely to the normal load in their planar extent, also results in a pronounced amplification of the output signal.

A further advantageous configuration includes that the load-bearing element is provided with an electric current generator, preferably a piezo element, that utilizes its deformation energy. This is useful, in particular, in a further advantageous embodiment in which the load-bearing element is provided with an electronic circuit realized as a control and signal processor, preferably having a transmission unit and antenna connected thereto, wherein the control and signal processor is able to transmit, as an output signal to an external receiver, an electrical quantity that is proportional to the elastic deformation of the load-bearing element.

In such an arrangement, the electrical power supply to the control and signal processor, and also to the transmission unit, can be effected by the piezo element. It is then no longer necessary to rely on the passive injection of quantities of energy from outside the load-bearing element. Such an internal energy supply also makes it easier to send the signal that is proportional to the deformation of the load-bearing element to receiver in the vehicle, such that it is not only the driver who is constantly informed about the load status. In this way, signals representing the load status can also be sent, via any other connected radio transmitter present in the vehicle, to a control center of a haulage company or fleet operator.

A further advantageous configuration includes that the load-bearing element is realized as a damping element for the respective spring element and is preferably arranged in the connection region between the spring element and the axle. As almost all load forces/weight forces are transmitted to the axle via these attachment points, such an arrangement provides particularly accurate values for the vehicle weight.

In the case of a chassis of a truck or associated trailer or semi-trailer that is provided with a leaf-spring suspension, the load-bearing element is advantageously realized as a damping element of the leaf spring and arranged, in the form of a damper block clamped between the leaf spring and the axle, as a connection between the leaf spring and the axle. The arrangement of such block dampers, clamped between the axle and the leaf spring, is a common configuration in the leaf-spring suspension of chassis for trucks. It is therefore very easy to adapt the normal chassis production process so that, instead of the block damper from the prior art, a damper block that is clamped between the leaf spring and the axle and that includes the measuring device according to the disclosure, or that is realized as such, is installed.

Accordingly, the disclosure is also directed toward a damping element, realized in such a manner and having an integrated force-measuring device, that is installed in a sprung chassis of a single-axle or multi-axle vehicle and arranged as a load-bearing element in the force transmission path between the superstructure and the axle. Also stressed is a chassis of a truck having mechanical leaf suspension, that has a force-measuring device realized as a load-bearing element.

As already indicated above, a method for determining the vehicle weight by use of a force-measuring device according to the disclosure includes that, in particular when the vehicle is stationary and during loading, the variation in electrical quantities that, in dependence on the loading of the vehicle, ensues from a variation in position or geometry of the electrodes, electrically conductive layers or electrically conductive elements provided in the load-bearing element made of elastomeric material, is compared, in an appropriately calibrated computing unit, with corresponding reference quantities for the unladen weight of the vehicle when stationary, and the actual weight of the vehicle is determined therefrom. This procedure makes it possible to establish the exact loading situation, for example, of a truck, not only before the start of journey, but also every time the journey is interrupted and at every stop at destination points where load is removed and new load is added.

It is also possible, by use of the measuring device according to the disclosure, to determine the dynamic forces acting upon a chassis, for instance upon a chassis of a truck. In this case, while the vehicle is travelling, the variation in electrical quantities that ensue in dependence on dynamic forces acting upon the vehicle and are generated by a variation in position or geometry of the electrodes, electrically conductive layers or electrically conductive elements provided in the load-bearing element made of elastomeric material, are compared, in appropriately calibrated computing units, with corresponding reference quantities or threshold values. As soon as such predefined threshold values are reached or exceeded, a signal is output, for example a warning signal to the driver, or a signal to the vehicle control system.

### BRIEF DESCRIPTION OF DRAWINGS

The invention will now be described with reference to the drawings wherein:

FIG. 1 shows a basic diagram providing an overview and context for the following figures;

FIG. 2 shows a basic diagram of the chassis construction of the rear axle of a truck, in a perspective view, and the arrangement there of a measuring device according to the disclosure;

FIG. 3 shows a schematic diagram of a possible arrangement of the measuring device according to the disclosure, realized as a damper block, in the chassis;

FIG. 4 shows a schematic diagram of a further possible arrangement of the measuring device according to the disclosure, realized as a damper block, in the chassis;

FIG. 5 shows, in the form of a basic diagram, a first arrangement of planar electrodes within a damper block according to the disclosure;

FIG. 6 shows, in the form of a basic diagram, a further arrangement of planar electrodes within a damper block according to the disclosure;

FIG. 7 shows a basic diagram of a further arrangement of planar electrodes within a damper block according to the disclosure that is provided between further elastomeric materials;

FIG. 8 shows a basic diagram of a measuring device according to the disclosure, realized as a damper block, in an embodiment in which two groups of planar electrodes that each act in combination are arranged next to one another within the damper block; and,

FIG. 9 shows a basic diagram of a measuring device according to the disclosure, realized as a damper block, in a further embodiment having a plurality of groups of planar electrodes acting in combination within a damper block.

### DETAILED DESCRIPTION

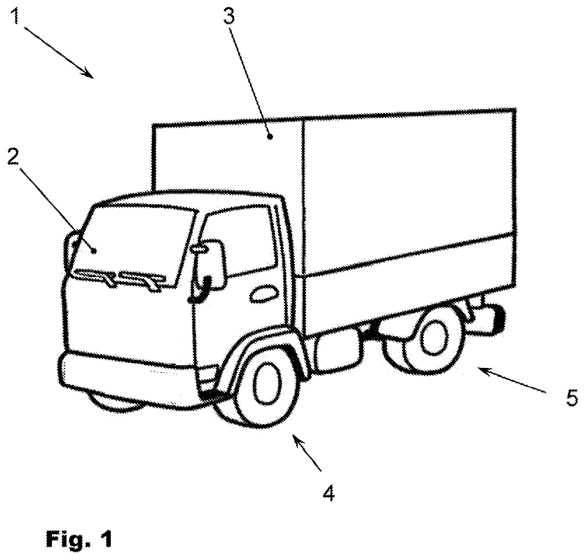

FIG. 1 shows, in the form of a basic diagram providing an overview and context for the following figures, a two-axle truck 1 with a driver's cab 2, a load floor, or load box 3, with the front axle 4 and the rear axle 5.

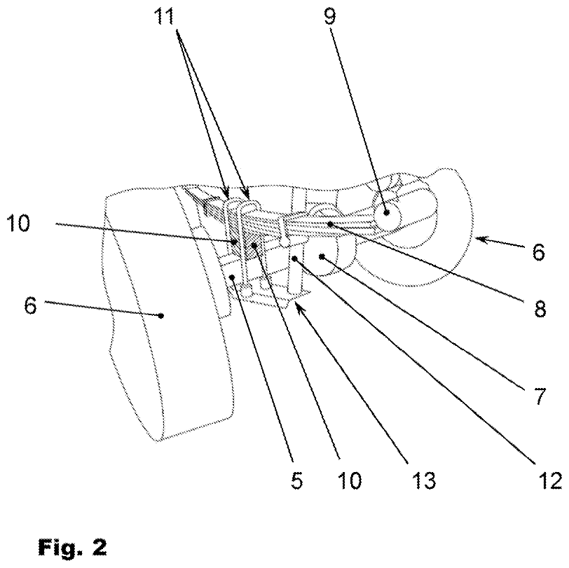

FIG. 2 shows, also in the form of a basic diagram, the chassis construction of the rear axle of the truck, in a perspective view from the rear left.

This shows the tires, or wheels 6, on the rear axle 5, which are driven via the drive transmission and differential 7. The rear axle 5 is connected via a layered leaf spring 8 to a frame member, not represented here, that carries the load box 3, also not represented so as to simplify FIG. 2.

The connection of the leaf spring 8 to the frame member is effected at both ends of the leaf spring via articulation points realized as movably mounted spring shackles 9, which are mounted in an articulated manner in the frame member.

The connection of the leaf spring 8 to the rear axle 5 is effected via an elastomeric damping element that, according to the disclosure, is realized as a measuring device in the form of a load-bearing element. The measuring device according to the disclosure is realized here in the form of a damper block 10 clamped between the leaf spring and the axle. Such damper blocks are already used in the prior art, but not realized as a measuring device, but rather as a simple monolithic rubber block.

The clamping of the damper block 10 realized according to the disclosure, arranged here between the underside of the layered leaf spring 8 and the upper side of the rear axle 5, is effected via steel clamps 11, which grip around the leaf spring 8 and rear axle 5 via corresponding shaped pieces and are firmly bolted under tension. Also visible is a shock absorber 12, which is attached both to a flange 13 of the axle and to the frame member, which is not shown here.

The damper block 10 according to the disclosure is constructed here from elastomeric material and arranged, as a load-bearing element, between the leaf spring 8 and the rear axle 5, but has electrically conductive layers integrated in the damper block, in this case layers of electrically conductive rubber that form a capacitive resistor, the capacitance of which is variable in proportion to the elastic deformation of the load-bearing element, that is, of the damper block 10.

Since the load forces/weight forces are transmitted to the axle(s) substantially via the respective load-bearing elements realized as damper block 10, the measuring device according to the disclosure provides particularly accurate values for the vehicle weight.

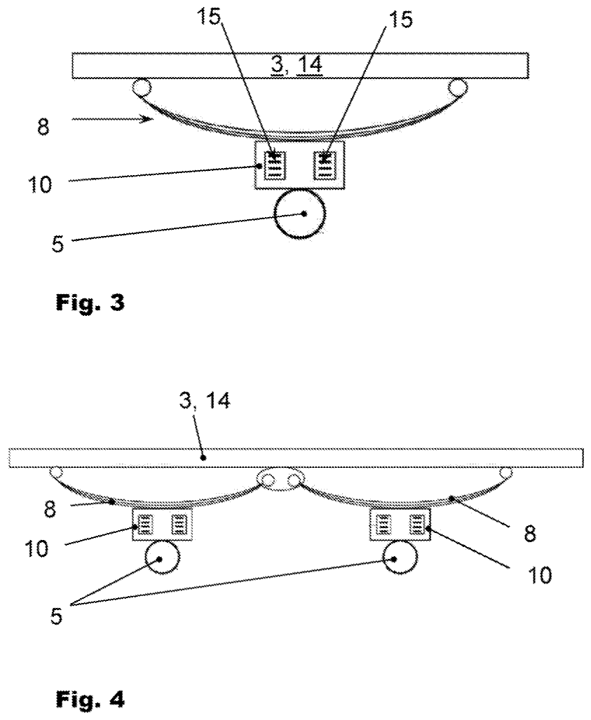

Represented in FIGS. 3 and 4 are possible arrangements of a measuring device according to the disclosure, realized as a damper block, in the chassis and in relation to the leaf spring and the frame, or superstructure, of the vehicle. In order to keep the diagram as simple as possible, no distinction has been made here in the representation of visible and invisible lines.

FIG. 3 shows, in the form of a schematic diagram, a damper block 10 realized according to the disclosure that is arranged, as a load-bearing element, between a leaf spring 8 and a rear axle 5. The leaf spring 8 is fastened at its outer ends via articulation points to a body 14, or to the lower frame of a load box 3.

Realized within the damper block 10 there are two groups of respectively four planar electrodes 15, which also undergo deformation when the elastomeric damper block 10 is deformed, as shown hereinafter.

FIG. 4 shows as an example the same basic arrangement of such a damper block 10 realized according to the disclosure, but for a double axle, in which two springs 8 are provided one behind the other and are each attached to a rear axle 5, with the damper block being integrated. FIGS. 3 and 4 show a view from one side. The arrangement of springs and damper blocks according to the disclosure is mirror-symmetrical with respect to the central axis on both sides of the axle suspension of a vehicle.

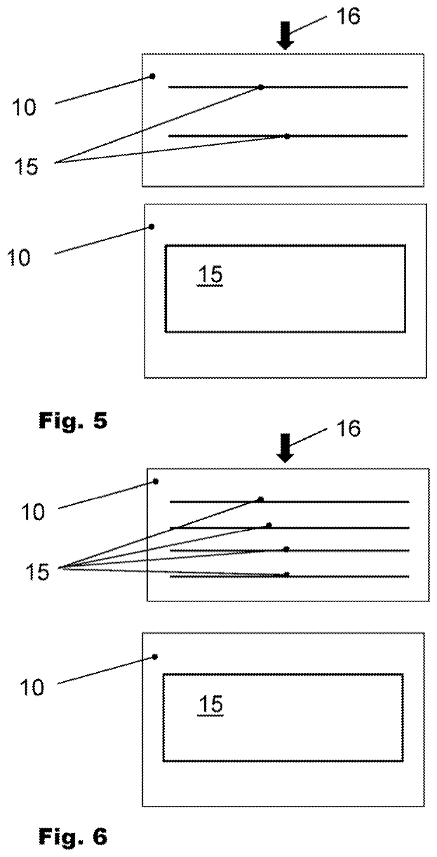

FIGS. 5 and 6 show basic diagrams, in enlarged form, of different arrangements of planar electrodes within a damper block 10 according to the disclosure. Here too, for the reasons already mentioned, no distinction has been made in the representation of visible and invisible lines. In the figures that follow, the operative direction of the weight force, or the load weight, is represented by the arrow 16.

FIG. 5 shows in the upper representation a view, and in the lower representation a top view, of a measuring device according to the disclosure realized as a damper block. It can be seen here that only two planar electrodes 15 are provided, which form a capacitive resistor and react proportionally to the elastic deformation of the load-bearing element/damper block by a change in capacitance.

FIG. 6, in a representation that is analogous to FIG. 5, shows in the upper part a view, and in the lower part a top view, of a measuring device according to the disclosure realized as a damper block 10, in which a total of four planar electrodes 15 are provided. Such an arrangement allows the strength of the output signal corresponding to the variation in capacitance to be maximized.

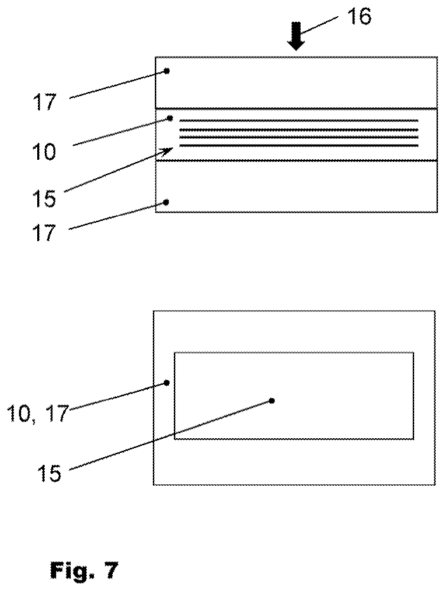

FIG. 7, as a basic diagram, shows in the upper representation a view, and in the lower representation a top view, of a measuring device according to the disclosure, in which the damping block 10 constitutes only the middle part of a load-bearing element. Arranged above and below the damping block 10 there are further damping materials/damping blocks 17 which, however, are nor realized according to the disclosure. Such a configuration makes it possible to realize an optimum between damping properties due to different materials and deformation properties in the damping block 10.

Here too, four planar electrodes 15, which form a capacitive resistor and react proportionally to the elastic deformation of the load-bearing element/damper block by a change in capacitance, are provided in the damping block 10 arranged in the middle between the damping materials 17.

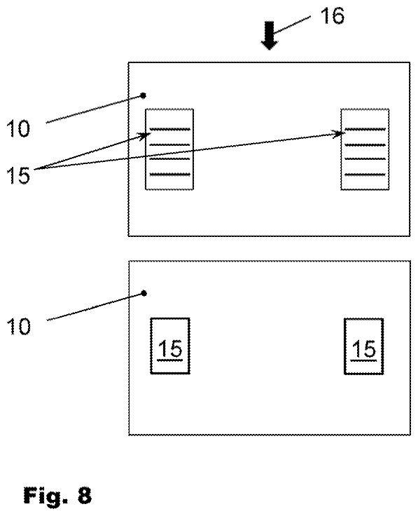

FIG. 8 shows in the upper part a view, and in the lower part a top view, of a measuring device according to the disclosure, realized as a damper block 10, in an embodiment in which two groups of planar electrodes 15, each acting in combination, are arranged next to one another within the damping block 10 in such a way that an electrical quantity that is proportional to the elastic deformation of sub-regions of the load-bearing element can be generated. If, for example, the damping block 10 deforms more on what in the drawing is its left side than on its right side, this can be detected by different capacitance changes in the groups of planar electrodes 15 realized as capacitive resistors. Such an arrangement makes it possible, on the one hand, to achieve amplification of the electrical signal in the case of symmetrical loading or also, on the other hand, to measure transverse forces or shear forces in the damping block, and thus in the chassis.

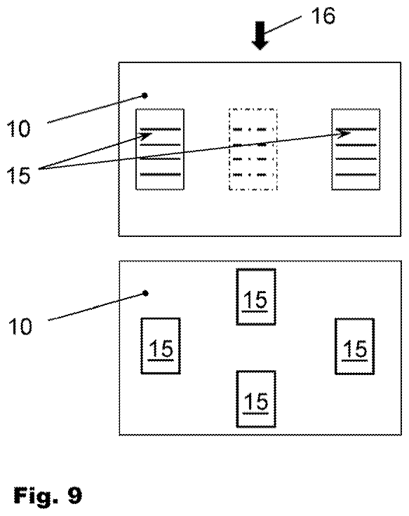

The same applies analogously to the embodiment represented in FIG. 9. FIG. 9 shows in the upper part a view, and in the lower part a top view, of a measuring device according to the disclosure, realized as a damper block 10, in an embodiment in which four groups of planar electrodes 15, each acting in combination, are arranged next to one another within the damping block 10 in such a way that an electrical quantity proportional to the elastic deformation of sub-regions of the load-bearing element can be generated. If, for example, the damping block 10 deforms more on what in the drawing is its upper left side than on its lower right side, this can be detected by different capacitance changes in the groups of planar electrodes 15 realized as capacitive resistors.

This arrangement can also be used to measure transverse forces or shear forces in the damping block, and thus in the chassis, this being advantageous, in particular, if there is a plurality of leaf springs on more than one axle.

It is understood that the foregoing description is that of the preferred embodiments of the invention and that various changes and modifications may be made thereto without departing from the spirit and scope of the invention as defined in the appended claims.

### LIST FO REFERENCE DESIGNATIONS (PART OF THE DESCRIPTION)

1 truck
2 driver's cab of the truck
3 load floor/load box
4 front axle
5 rear axle
6 wheels
7 drive transmission and differential
8 leaf spring
9 spring shackle
10 damper block (measuring device)
11 steel clamp
12 shock absorber
13 flange for shock absorber
14 body/superstructure
15 planar electrode (conductive layer)
16 operative direction of the weight force, load weight

1. A force-measuring device in a sprung chassis of a vehicle having a superstructure and an axle conjointly defining a force transmission path therebetween, the vehicle further having a plurality of spring elements arranged in said force transmission path between said axle and said superstructure; said force-measuring device comprising:
a load-bearing element arranged in said force transmission path between said superstructure and said axle in such a way that said spring elements are each connected to said axle and/or to said superstructure via said load-bearing element;
said load-bearing element being made substantially of an elastically deformable plastic or of an elastomeric material;
said load-bearing element including a plurality of electrically conductive elements mutually spaced apart and insulated from one another via said elastically deformable plastic or said elastomeric material; and,
said plurality of electrically conductive elements being variable absolutely and/or relative to one another with respect to position thereof or geometry thereof by a deformation of said load-bearing element effected under load and so generating a detectable electrical quantity proportional to the elastic deformation of said load-bearing element.

2. The force-measuring device of claim 1, wherein said plurality of electrically conductive elements includes electrodes and electrically conductive layers.

3. The force-measuring device of claim 2, wherein said electrically conductive elements are mutually spaced apart and are arranged within said load-bearing element and form a capacitive resistor having a capacitance which is variable in proportion to the elastic deformation of said load-bearing element and is detectable.

4. The force-measuring device of claim 1, wherein at least one of the following applies: i) said load-bearing element is configured as a multi-part unit; and, ii) said load-bearing element is made up of a plurality of elastically deformable plastics or elastomeric materials.

5. The force-measuring device of claim 2, wherein a plurality of groups of said electrically conductive elements each act in combination; said groups are arranged next to one another within said load-bearing element in such a way that an electrical quantity that is proportional to the elastic deformation of sub-regions of the load-bearing element can be generated.

6. The force-measuring device of claim 1, wherein a plurality of groups of said electrically conductive elements that each act in combination are arranged in groups above one another within the load-bearing element in such a way that an electrical quantity that is proportional to the elastic displacement or torsion of the load-bearing element can be generated.

7. The force-measuring device of claim 1, wherein said load-bearing element has an electric current generator that utilizes the deformation energy thereof.

8. The force-measuring device of claim 7, wherein said electric current generator is a piezo element that utilizes the deformation energy thereof.

9. The force-measuring device of claim 1, wherein said load-bearing element includes an electronic circuit realized as a control and signal processor; and, said control and signal processor is configured to transmit an output signal to an external receiver as an electrical quantity that is proportional to the elastic deformation of the load-bearing element.

10. The force-measuring device of claim 9, wherein said control and signal processor has a transmission unit and an antenna connected thereto.

11. The force-measuring device of claim 1, wherein said load-bearing element is realized as a damping element for the respective spring element.

12. The force-measuring device of claim 11, wherein said load-bearing element is arranged, in the form of a damper block, in a connection region between the spring element and the axle.

13. The force-measuring device of claim 11, wherein, in the chassis of said vehicle, said load-bearing element is realized as a damping element of a leaf spring and arranged, in the form of a damper block clamped between said leaf spring and the rear axle, as a connection between the leaf spring and the axle.

14. A damping element comprising:
a force-measuring device including:
a load-bearing element arranged in said force transmission path between said superstructure and said axle in such a way that said spring elements are each connected to said axle and/or to said superstructure via said load-bearing element;
said force-measuring device being made substantially of an elastically deformable plastic or of an elastomeric material;
said load-bearing element including a plurality of electrically conductive elements mutually spaced apart and insulated from one another via said elastically deformable plastic or said elastomeric material;
said plurality of electrically conductive elements being variable absolutely and/or relative to one another with respect to position thereof or geometry thereof by a deformation of said load-bearing element effected under load and so generating a detectable electrical quantity proportional to the elastic deformation of said load-bearing element;
said force-measuring device being in a sprung chassis of said vehicle; and,
wherein said damping element is arranged as a load-bearing element in said force transmission path between the superstructure and the axle.

15. A chassis of a truck comprising:
a mechanical leaf suspension; and,
a force-measuring device including:
a load-bearing element arranged in said force transmission path between said superstructure and said axle in such a way that said spring elements are each connected to said axle and/or to said superstructure via said load-bearing element;
said load-bearing element being made substantially of an elastically deformable plastic or of an elastomeric material;
said load-bearing element including a plurality of electrically conductive elements mutually spaced apart and insulated from one another via said elastically deformable plastic or said elastomeric material;
said plurality of electrically conductive elements being variable absolutely and/or relative to one another with respect to position thereof or geometry thereof by a deformation of said load-bearing element effected under load and so generating a detectable electrical quantity proportional to the elastic deformation of said load-bearing element; and,
said load-bearing element being realized as a damping element for the respective spring element.

16. A method for determining a vehicle weight by use of a force-measuring device, the vehicle having a sprung chassis and a superstructure, the force-measuring device including: a load-bearing element arranged in said force transmission path between said superstructure and said axle in such a way that said spring elements are each connected to said axle and/or to said superstructure via said load-bearing element; said load-bearing element being made substantially of an elastically deformable plastic or of an elastomeric material; said load-bearing element including a plurality of electrically conductive elements mutually spaced apart and insulated from one another via said elastically deformable plastic or said elastomeric material; and, said plurality of electrically conductive elements being variable absolutely and/or relative to one another with respect to position thereof or geometry thereof by a deformation of said load-bearing element effected under load and so generating a detectable electrical quantity proportional to the elastic deformation of said load-bearing element; the method comprising the steps of:
when the vehicle is stationary, a variation in electrical quantities that, in dependence on the loading of the vehicle, ensues from a variation in position or geometry of the electrically conductive elements in the load-bearing element made of elastically deformable plastic or elastomeric material, is compared, in an appropriately calibrated computing unit, with corresponding reference quantities for the unladen weight of the vehicle when stationary; and,
the actual weight of the vehicle is determined therefrom.

17. A method for determining dynamic forces acting upon a chassis, the method comprising:
while a vehicle is travelling, a variation in electrical quantities that, in dependence on the dynamic forces acting upon the vehicle, ensues from a variation in position or geometry of electrically conductive elements in a load-bearing element made of deformable plastic or elastomeric material, is compared, in an appropriately calibrated computing unit, with corresponding reference quantities or threshold values and, if these are exceeded, a signal is output.
